(19) United States
(12) Patent Application Publication
(10) Pub. No.: US 2009/0086044 A1
(43) Pub. Date: Apr. 2, 2009

(54) MOVING-IMAGE REPRODUCING APPARATUS AND MOVING-IMAGE REPRODUCING METHOD

(75) Inventor: Hiroyuki KINEMURA, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/237,627

(22) Filed: Sep. 25, 2008

(30) Foreign Application Priority Data
Sep. 28, 2007 (JP) 2007-255564

(51) Int. Cl. H04N 5/225; H04N 5/222

(52) U.S. Cl. 348/220.1; 348/333.05; 348/231.2; 348/E05.024

(57) ABSTRACT

In a moving-image reproducing apparatus for reproducing a moving image file formed of a plurality of frames, the moving-image reproducing apparatus configured to include: a first displayer for displaying one frame of reference of the moving image file; a second displayer for collectively displaying reduced images of image data of a first number of frames forming the moving image file, when a predetermined operation is performed in a display state by the first displayer, and a third displayer for collectively displaying reduced images of image data of a second number of frames forming the moving image file, when a predetermined operation is performed in a display state by the second displayer. The second number of frames is larger than the first number of frames.

### CROSS REFERENCE OF RELATED APPLICATION

The disclosure of Japanese Patent Application No. 2007-255564 which was filed on Sep. 28, 2007 is incorporated herein by reference.

### BACKGROUND OF THE INVENTION

1. Field of the Invention

The present invention relates to a moving-image reproducing apparatus. More particularly, the present invention relates to a moving-image reproducing apparatus and a moving-image reproducing method, for reproducing a moving image file recorded in a memory of an electronic camera such as a digital camera, for example.

2. Description of the Related Art

In a digital camera, when a desired file is reproduced from a plurality of files such as a still image file including a moving image file and a music file which are recorded in a memory, each thumbnail is multi-displayed on a display portion of an electronic camera. A user selects one thumbnail out of the multi-display and depresses a determining key, and so on, so as to reproduce the desired file.

Also, there is an image reproducing apparatus for allowing the user to distinguish the still image file from the moving image file in a visually understandable manner, at a time of displaying a plurality of thumbnails in which the still image file and the moving image file are mixed.

However, in this image reproducing apparatus, in a multi-image of thumbnails in which a plurality of types of file formats are mixed, the file formats of the respective thumbnails are displayed in an understandable manner. In spite thereof, when a specified thumbnail is the moving image file, there has been no measures taken in which an operation of a content of the moving image file is facilitated or rendered visually understandable for a user.

### SUMMARY OF THE INVENTION

According to the present invention, a moving-image reproducing apparatus for reproducing a moving image file formed of a plurality of frames, comprises: a first displayer for displaying one frame of reference of the moving image file; a second displayer for collectively displaying reduced images corresponding to image data of a first predetermined number of frames, out of the plurality of frames forming the moving image file, when a predetermined operation is performed in a display state by the first displayer; and a third displayer for collectively displaying reduced images corresponding to image data of a second predetermined number of frames, the second predetermined number being larger than the first predetermined number, out of the plurality of frames forming the moving image file, when the predetermined operation is performed in a display state by the second displayer.

Preferably, each of frames corresponding to the reduced images of a first predetermined number of frames is image data designated by a first interval from the moving image file.

Preferably, each of frames corresponding to reduced images of the second predetermined number of frames is image data designated by an interval shorter than the first interval from the moving image file.

Preferably, in one of a display of reduced images of the first predetermined number of frames and a display of reduced images of the second predetermined number of frames, there are further provided: a first selector for selectively selecting the reduced images; a detector for detecting time positions in a moving image file of the image data corresponding to the reduced images selected by the first selector; and a reproducer for reproducing the moving image file from the time positions.

Preferably, there are further provided: a still-image reproducer for reproducing a still image file; a magnifying-process acceptor for accepting a magnifying operation for applying a magnifying process in an electronic manner to a still image of the still image file reproduced in the still-image reproducer; and a magnifying processor for executing the magnifying process according to the magnifying operation, in which the predetermined operation is the magnifying operation.

According to the present invention, a moving-image reproducing apparatus for reproducing a moving image file formed of a plurality of frames, comprises: a first displayer for displaying one frame of reference of the moving image file; an operator for accepting an operation instruction for executing a predetermined operation; a counter for counting the number of times of the operation instruction; and a second displayer for changing reduced images of image data of a plurality of frames of the moving image file, according to output of the counter, so as to collectively display the changed reduced images.

According to the present invention, a moving-image reproducing method for reproducing a moving image file formed of a plurality of frames, the moving-image reproducing method comprises: a first step of displaying one frame of reference of the moving image file; a second step of collectively displaying reduced images corresponding to image data of a first predetermined number of frames, out of the plurality of frames forming the moving image file, when a predetermined operation is performed in a display state by the first displayer; and a third step of collectively displaying reduced images corresponding to image data of a second predetermined number of frames, the second predetermined number being larger than the first predetermined number, out of the plurality of frames forming the moving image file, when the predetermined operation is performed in a display state by the second displayer.

The above described features and advantages of the present invention will become more apparent from the following detailed description of the embodiment when taken in conjunction with the accompanying drawings.

### BRIEF DESCRIPTION OF THE DRAWINGS

FIG. 1 is an outline view showing appearance of an electronic camera, which is one embodiment of the present invention;

FIG. 2 is a block diagram showing a configuration of the electronic camera, which is one embodiment of the present invention;

FIG. 3 is an illustrative view showing one example of a thumbnail display image, which is one embodiment of the present invention;

FIG. 4 is an illustrative view showing one example of a 1-frame reproduced image of a moving image file, which is one embodiment of the present invention;

FIG. 5 is an illustrative view showing one example of first reduced display images, which is one embodiment of the present invention;

FIG. 6 is an illustrative view showing one example of second reduced display images, which is one embodiment of the present invention;

FIG. 7 is an illustrative view showing another example of the second reduced display images, which is one embodiment of the present invention;

FIG. 8 is an illustrative view showing another example of the 1-frame reproduced image of a moving image file, which is one embodiment of the present invention;

FIG. 9(a) is an illustrative view showing one example of a reproduced image of a still image file, which is one embodiment of the present invention;

FIG. 9(b) is an illustrative view showing another example of the reproduced image of the still image file, which is one embodiment of the present invention;

FIG. 10 is a flowchart showing one portion of one example of an operation of one embodiment of the present invention;

FIG. 11 is a flowchart showing one portion of a continuation of FIG. 10 of the present invention;

FIG. 12 is a flowchart showing another portion of a continuation of FIG. 10 of the present invention; and

FIG. 13 is a flowchart showing still another portion of a continuation of FIG. 10 of the present invention.

### DETAILED DESCRIPTION OF THE PREFERRED EMBODIMENTS

In this embodiment, as one example of a moving-image reproducing apparatus, a mode of an electronic camera 10 is described.

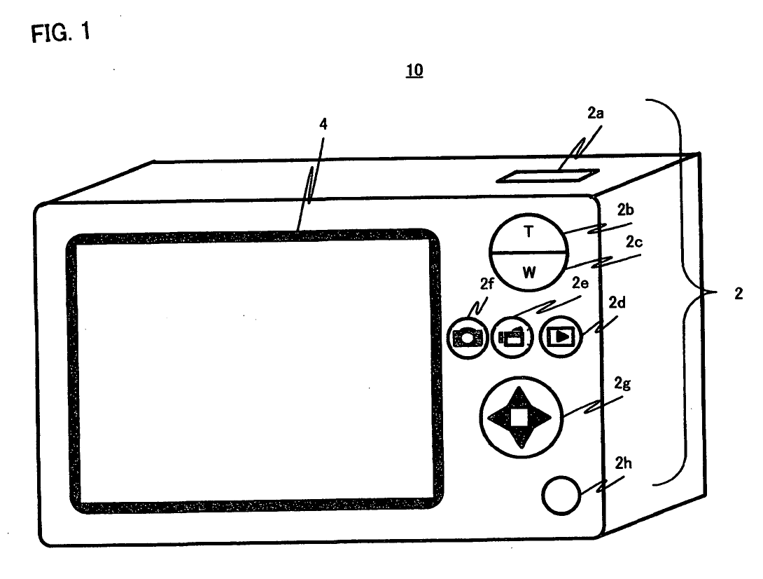

An outline view of the electronic camera 10 is shown in FIG. 1. The electronic camera 10 in FIG. 1 is provided with at least an imaging portion not shown, an operating portion 2, and a display portion 4. In the imaging portion, an imaging operation is performed. Buttons 2a to 2h configuring the operating portion 2 are described in detail. The button 2a is a shutter button for instructing an imaging operation, the button 2b is a TELE button for electronically magnifying a photographed image at a time of reproducing, and the button 2c is a WIDE button for electronically reducing a photographed image. Herein, the TELE button 2b and the WIDE button 2c are collectively called a zoom button 21. Furthermore, by operating the TELE button 2b and the WIDE button 2c at a time of photographing, a subject is electronically magnified and reduced.

The button 2d is a reproduction mode button, and when this button is depressed, a reproduction mode is entered. Likewise, the button 2f is a still-image photographing mode button, the button 2e is a moving-image photographing mode button, and when these buttons are depressed, respective modes are entered. The button 2g is a cursor key for selecting and instructing an item, etc., displayed within the display portion 4 when this button is operated in four directions, and determines the item, etc., when a central portion of the four directions is depressed. Then, the button 2h is a menu button for displaying a selectable item, etc., on the display portion 4.

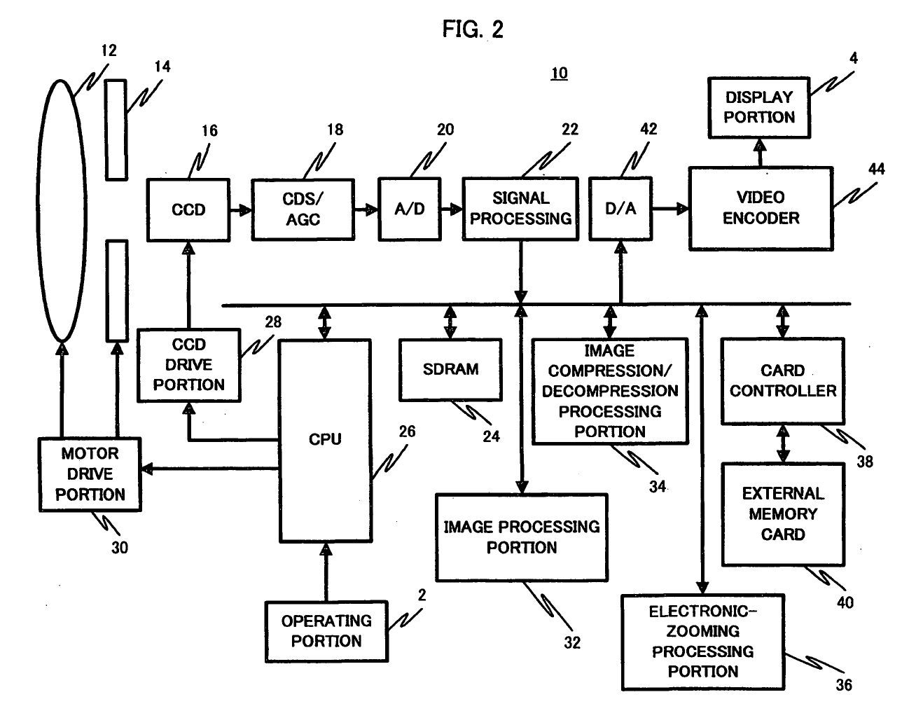

With reference to FIG. 2, which is a block diagram showing an inside of the electronic camera 10 shown in FIG. 1, the electronic camera 10 is described in more detail. The electronic camera 10 is configured to include: the operating portion 2, the display portion 4, an imaging lens 12, an aperture 14, a CCD imager 16, a CDS (Correlated Double Sampling)/AGC (Auto Gain Control) circuit 18, an A/D converter circuit 20, a signal processing circuit 22, an SDRAM 24, a CPU 26, a CCD drive portion 28, a motor drive portion 30, an image processing portion 32, an image compression/decompression processing portion 34, an electronic-zooming processing portion 36, a card controller 38, an external memory card 40, a D/A converter circuit 42, and a video encoder 44.

The imaging lens 12 images an optical image of the subject onto an imaging surface of the CCD imager 16, which is an imaging device. Furthermore, the imaging lens 12 is adjusted in its movement in an optical axis direction based on an output signal of the CCD imager 16. The aperture 14 is controlled to adjust light that enters the CCD imager 16 from the imaging lens 12. Adjustments of the imaging lens 12 and the aperture 14 are performed by the motor drive portion 30. It is noted that the motor drive portion 30 is configured by two motors not shown that separately adjust the imaging lens 12 and the aperture 14.

When the optical image of the subject is imaged on the imaging surface of the CCD imager 16 by the imaging lens 12, a photoelectronic conversion is performed in each photodiode, which is one portion configuring the CCD imager 16. The CCD imager 16 outputs a signal of electric charges accumulated depending on an intensity of light and a time period as an analog imaging signal according to various types of pulse waveforms necessary for driving, produced by the CCD drive portion 28, the CCD imager 16.

The CDS/AGC circuit 18 decreases noise of the analog imaging signal outputted from the CCD imager 16, and automatically adjusts a level of the analog imaging signal.

The A/D converter circuit 20 converts the analog imaging signal outputted from the CDS/AGC circuit 18 into digital image data.

The signal processing circuit 22 performs a color separation based on the digital image data by the A/D converter circuit 20 so as to create R, G, and B signals, as three color signals, for each pixel of the CCD imager 16. Then, a color temperature detection is performed on the three color signals, and by color temperature control, a gain adjustment is performed on each of the signals. Next, a process for converting each of the signals into a Y signal, which is a luminance signal, and U and V signals, which are two color-difference signals, is performed.

The CPU 26 is connected to the operating portion 2, the signal processing circuit 22, the SDRAM 24, the CCD drive portion 28, the motor drive portion 30, the image processing portion 32, the image compression/decompression processing portion 34, the electronic-zooming processing portion 36, and the card controller 38. The CPU 26 performs control on the signal processing circuit 22, the SDRAM 24, the CCD drive portion 28, the motor drive portion 30, the image processing portion 32, the image compression/decompression processing portion 34, the electronic-zooming processing portion 36, and the card controller 38, according to programs accommodated in an internal memory not shown.

As described above, the operating portion 2 is configured by the various types of buttons or keys 2a to 2h. When a still-image imaging mode state is entered as a result of the still-image photographing mode button 2f being depressed, if the shutter button 2a is depressed so as to perform a still-image photographing operation, the CPU 26 causes the imaging lens 12, the aperture 14, the CCD imager 16, the CDS/AGC circuit 18, the A/D converter circuit 20, and the signal processing circuit 22 to perform the above-described processes on an optical image of a 1-frame subject. The CPU 26 causes the SDRAM 24 to temporarily accommodate digital image data, which is Y, U, and V signals obtained by the signal processing circuit 22.

Then, the 1-frame digital image data temporarily accommodated is compressed in a JPEG format by a JPEG codec, in this case, in the image compression/signal processing portion 34. The compressed compression digital image data is accommodated in the SDRAM 24 again.

Furthermore, thumbnail data is generated from the 1-frame digital image data temporarily accommodated, and the generated thumbnail data is accommodated in the SDRAM 24. The accommodated thumbnail data is subjected to a JPEG compression by the JPEG codec in the image compression/decompression processing portion 34. The compressed compression thumbnail data is accommodated in the SDRAM 24 again.

Then, the compression digital image data and the compression thumbnail data are recorded as one still image file in the external memory card 40 as a result of the CPU 26 controlling the card controller 38.

In a moving-image photographing mode as a result of the moving-image photographing mode button 2e being operated, when the shutter button 2a is depressed, the moving-image photographing operation is performed, and a moving-image process is executed until a moving-image photographing is ended as a result of the shutter button 2a being depressed again The moving-image process is a process similar to that in which a still-image photographing process of 30 frames is continuously performed in one second, for example. The moving-image process is performed until the digital image data, which is the Y, U, and V signals, is temporarily accommodated, by as many as a moving-image photographing time period, in the SDRAM 24.

Then, when an operation of ending the moving-image photographing is performed, a plurality of continued digital image data accommodated in the SDRAM 24 are subjected to a moving-image compression by a Motion JPEG codec, in this case, in the image compression/decompression processing portion 34, and accommodated in the SDRAM 24 again.

From the plurality of digital image data recorded in the SDRAM 24, thumbnail data of a first one frame is generated. Then, the thumbnail data is accommodated in the SDRAM 24, and is then subjected to a JPEG compression by the JPEG codec in the image compression/signal processing portion 34. The compressed compression thumbnail data is accommodated in the SDRAM 24 again.

Then, the plurality of compressed continued compression image data and compression thumbnail data are recorded in the external memory card 40 as one moving image file as a result of the card controller 38 being controlled.

When the reproduction mode button 2d is depressed, a latest still image file or a latest moving image file, recorded in the external memory card 40, is reproduced. In a case of the moving image file, a first one frame of the plurality of continued digital image data is reproduced, and when the central portion of the cursor key 2g is depressed, the moving image file is reproduced.

More specifically, in a case that the still image file is reproduced, the CPU 26 controls the card controller 38 so that the compression image data of the still image file recorded in the external memory card 40 is temporarily accommodated in the SDRAM 24. The compression image data, in a case of the still image file, accommodated in the SDRAM 24 is subjected to a decompression process by the JPEG codec in the image compression/decompression processing portion 34. The decompression-processed digital image data is temporarily accommodated in the SDRAM 24 and then converted into an analog image signal by the D/A converter circuit 42. The video encoder 44 converts into an NTSC signal based on the analog image data from the D/A converter circuit 42, and the converted NTSC signal is displayed on the display portion 4.

In a case that the moving image file is reproduced, the CPU 26 controls the card controller 38 so that the plurality of compression image data of the moving image file recorded in the external memory card 40 is temporarily accommodated in the SDRAM 24. The plurality of compression image data accommodated in the SDRAM 24 are subjected to a decompression process by the Motion JPEG codec in the image compression/decompression processing portion 34. The plurality of decompression-processed digital image data are temporarily accommodated in the SDRAM 24, and then converted into analog image signals by the D/A converter circuit 42 in a time sequence. The video encoder 44 converts into an NTSC signal based on the analog image data from the D/A converter circuit 42, and the converted NTSC signals are successively displayed on the display portion 4.

Furthermore, in a reproduction mode state and a photographing mode state, a character generating portion not shown is caused to generate a character, and the character is displayed and superposed on the image displayed on the display portion 4. Examples of characters include a frame mark for indicating a selected thumbnail on a thumbnail display image in a thumbnail display.

Then, when the left direction or the right direction out of the four directions of the cursor key 2g is depressed in a state that the still image of the still image file or the moving image file is reproduced on the display portion 4, 1-frame image of the still image or the moving image reproduced on the display portion 4 is updated.

Additionally, when the TELE button 2b is depressed in a state that the still image file is being reproduced, a magnifying process is performed on the digital image data of the displayed still image file by the electronic-zooming processing portion 36, and as a result, the magnifying-processed digital image data is displayed on the display portion 4.

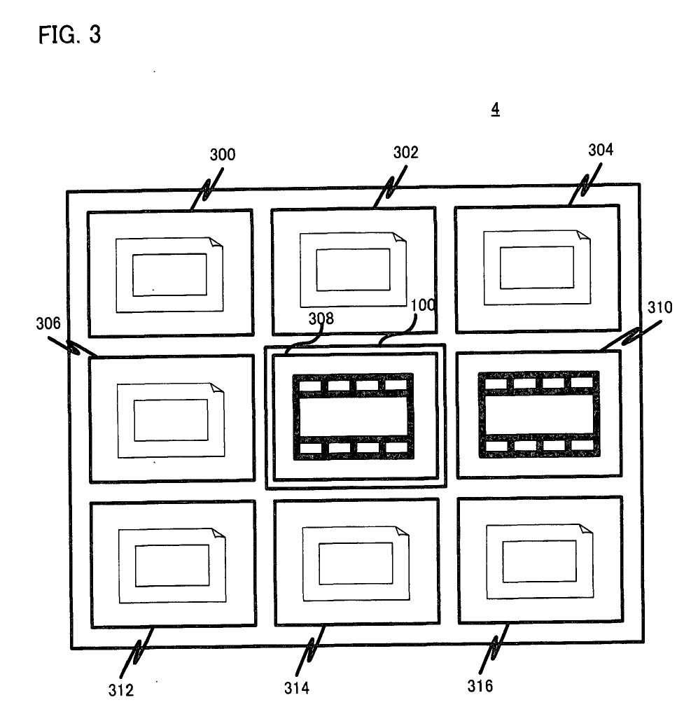

Alternatively, when the WIDE button 2c is depressed in a state that the still image file or the moving image file is being reproduced, a thumbnail display image configured by nine thumbnails 300 to 316 of the still image file and the moving image file recorded in the external memory card 40 is displayed, for example, as shown in FIG. 3.

The thumbnail display image data configured by the nine thumbnails is accommodated in a buffer not shown of one portion of the SDRAM 24, and converted into an analog image signal by the D/A converter circuit 42. The video encoder 44 converts into an NTSC signal based on the analog image signal from the D/A converter circuit 42, and the converted NTSC signal is displayed on the display portion 4.

Then, the user is able to select a desired thumbnail from the nine thumbnails by depressing the cursor key 2g in the four directions. A frame mark 100 is placed on the selected thumbnail. When the central portion of the cursor key 2g is depressed, which is regarded as a determination operation, 1-frame digital image data corresponding to the selected thumbnail is displayed on the display portion 4.

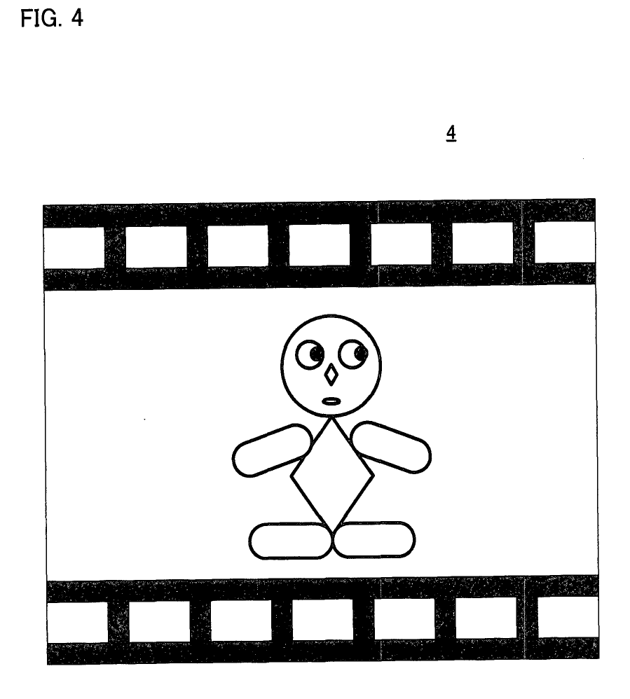

Herein, a description is given of a case in which the selected thumbnail is the moving image file. When a thumbnail 308, for example, which is the moving image file, is selected from the thumbnail display image configured by the nine thumbnails shown in FIG. 3, a first 1-frame of the moving image file is displayed on the display portion 4, as shown in FIG. 4.

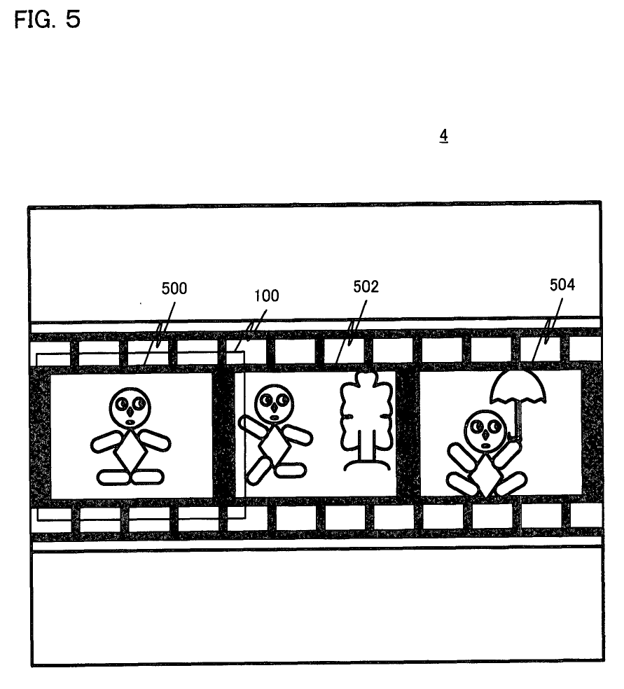

When the TELE button 2b is depressed in a display state shown in FIG. 4, a first reduced display image configured by three first reduced images arranged in a lateral direction is displayed on the display portion 4, as shown in FIG. 5. The three first reduced images are described in detail. When the TELE button 2b is depressed, the CPU 26 detects a total number of frames of the selected moving image file. Then, the CPU 26 determines the frame corresponding to an even point at which the number of frames obtained at a time of dividing the detected total number of frames by two becomes even. For example, in a setting that 30 frames are fetched in one second, as the moving-image photographing process, when the moving-image photographing is performed for one minute, 1800 frames, which is the total number of frames, are recorded as the moving image file. The even point at which the number of frames becomes even when the 1800 frames are divided by two is a 900th frame and a 901st frame. However, in this case, the 900th frame is used as the frame corresponding to the even point. Then, out of all the frames, the first one frame, the last one frame, and the one frame determined as the even point are designated, and temporarily accommodated in the SDRAM 24.

Then, from 3-frame digital image data, i.e., one frame each, accommodated in the SDRAM 24, first reduced image data is generated, and the resultant image is accommodated in the buffer of one portion of the SDRAM 24 for displaying the first reduced display image, and the accommodated image is converted into an analog image signal by the D/A converter circuit 42. The video encoder 44 converts into an NTSC signal based on the analog image signal from the D/A converter circuit 42, and the converted NTSC signal is displayed on the display portion 4.

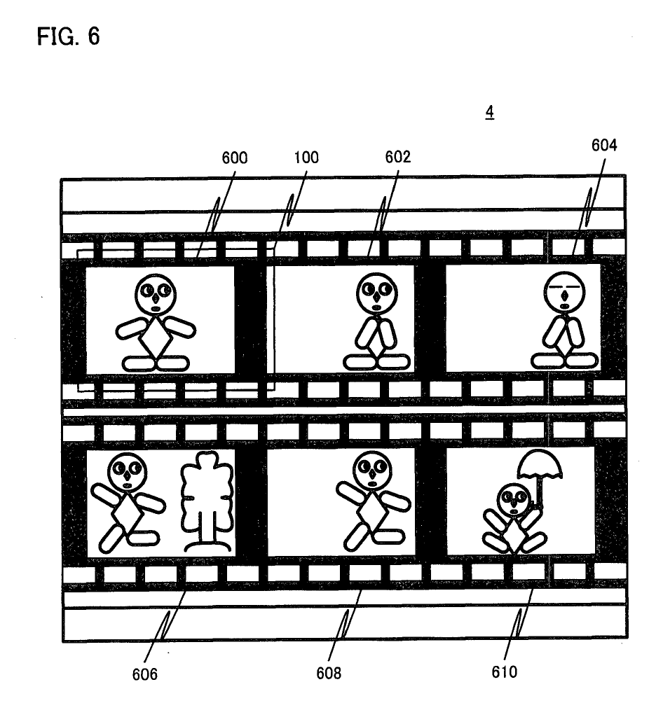

When the TELE button 2b is depressed again in the display state shown in FIG. 5, a second reduced display image configured by six second reduced images is displayed on the display portion 4, as shown in FIG. 6.

The six second reduced images are determined according to a method similar to that with respect to the above-described three first reduced images. In particular, when the TELE button 2b is depressed, the CPU 26 detects the total number of frames of the selected moving image file, determines four frames corresponding to even points at which the number of frames is even when the total number of frames is divided by five, designates the first one frame, the last one frame, and the determined four frames, out of all the frames, and causes the SDRAM 24 to temporarily accommodate these frames.

Thus, in the thumbnail display, the nine thumbnails are displayed. When the TELE button 2b is depressed in the display state shown in FIG. 4, the first reduced display image configured by the three first reduced images arranged in a lateral direction is displayed, as shown in FIG. 5. When the TELE button 2b is depressed again in the display state shown in FIG. 5, the second reduced display image configured by the six second reduced images is displayed, as shown in FIG. 6. Thus, the second reduced images may be distinguished from the thumbnail. Furthermore, the first reduced display image is displayed larger than the second reduced display image, and the second reduced image is displayed larger than the thumbnail. Therefore, an image more detailed than the thumbnail may be viewed, and thus, a content of the moving image file becomes more understandable. Additionally, the thumbnail, the first reduced display image, and the second reduced display image are displayed by respectively different numbers of images, and therefore, a user is not confused as to whether the thumbnail is displayed or the content of the moving image file is displayed.

Next, from the 6-frame digital image data, i.e., one frame each, accommodated in the SDRAM 24, second reduced image data is generated, and accommodated in a buffer, not shown, of one portion of the SDRAM 24, for displaying the second reduced display image. A process for displaying on the display portion 4 is similar to that for displaying the three first reduced images.

The thumbnail display image, the first reduced display image, and the second reduced display image are respectively shown in FIG. 3, FIG. 5, and FIG. 6, and in the respective display images, the frame mark 100 for allowing the user to select a desired image is also displayed. The frame mark 100 is placed so as to enclose the thumbnail and the first or second reduced image.

For example, in the thumbnail display image shown in FIG. 3, out of the nine thumbnails 300 to 316 in upper, middle, and lower columns arranged laterally, the frame mark is placed on the thumbnail 308 at a center. In the first reduced display image shown in FIG. 5, out of the three first reduced images 500 to 504 arranged laterally, the frame mark 100 is placed on the first reduced image 500 at a leftmost position. In the second reduced display image shown in FIG. 6, out of the six second reduced images 600 to 610 in upper and lower columns arranged laterally, the frame mark 100 is placed on the second reduced image 600 at a leftmost position in the upper column.

When the cursor key 2g is operated in each of states, the selected thumbnail, first reduced image, and second reduced image, each of which is enclosed by the frame mark 100, are changed.

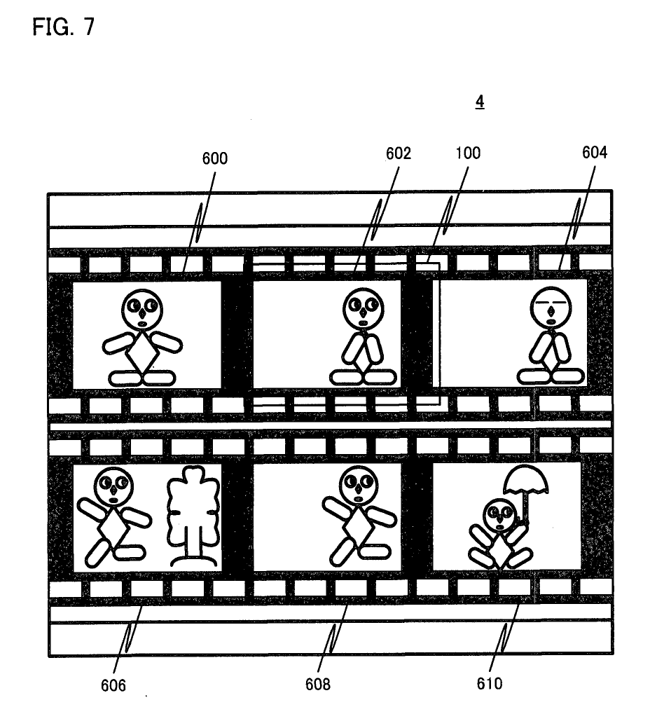

For example, in the second reduced display image shown in FIG. 6, in a state that the frame mark 100 is currently placed on the second reduced image 600 and when the cursor key 2g is depressed in a right direction, the frame mark 100 representing the selected second display image is moved from a position enclosing the second reduced image 600 to a position enclosing the second reduced image 602, as shown in the second reduced display image shown in FIG. 7.

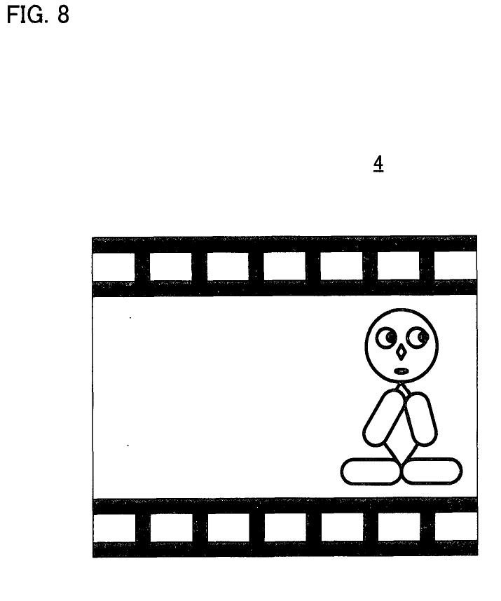

Next, when the central portion of the cursor key 2g is depressed, 1-frame digital image data corresponding to the second reduced image 602, which is the selected second reduced image, is displayed as shown in FIG. 8. When the central portion of the cursor key 2g is depressed again, the digital image data is used as a head frame of the moving-image reproducing process, and the moving-image reproducing process of the moving image file is performed in a time sequence.

Although the description is returned, likewise, in the first reduced image shown in FIG. 5, in a state that the frame mark 100 is currently placed on the first reduced image 500, and in this case, for example, when the central portion of the cursor key 2g is depressed without a depression of the right and left directions of the cursor key 2g, 1-frame digital image data corresponding to the first reduced image 602, which is the selected first reduced image, is displayed as shown in FIG. 4, and the moving-image reproducing processing similar to that in FIG. 8 is performed.

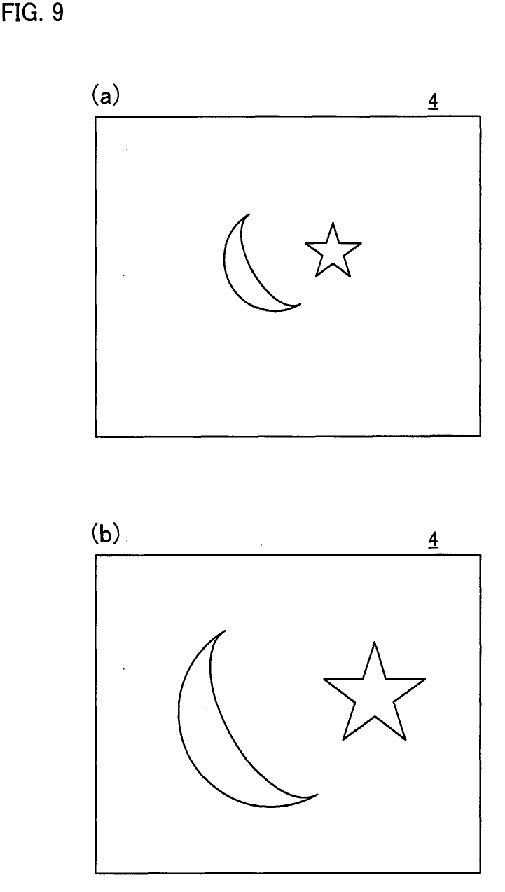

Alternatively, a case that the selected thumbnail is the still image file is described. When the thumbnail 300, which is the still image file, for example, is selected from the thumbnail display image configured by the nine thumbnails shown in FIG. 3, a still image is displayed on the display portion 4, as shown in FIG. 9(a).

When the TELE button 2b is depressed in the display state of FIG. 9, the digital image data of the still image file corresponding to the thumbnail 300 is temporarily accommodated in the SDRAM 24, and the digital image data is subjected to a pixel interpolation in the electronic-zooming processing portion 36, so that a magnified image is displayed on the display portion 4, as shown in FIG. 9(b). Furthermore, when the WIDE button 2c is depressed in a state that the magnified image is displayed, the still image before the magnified still image is displayed, i.e., the still image shown in FIG. 9(a), is displayed on the display portion 4.

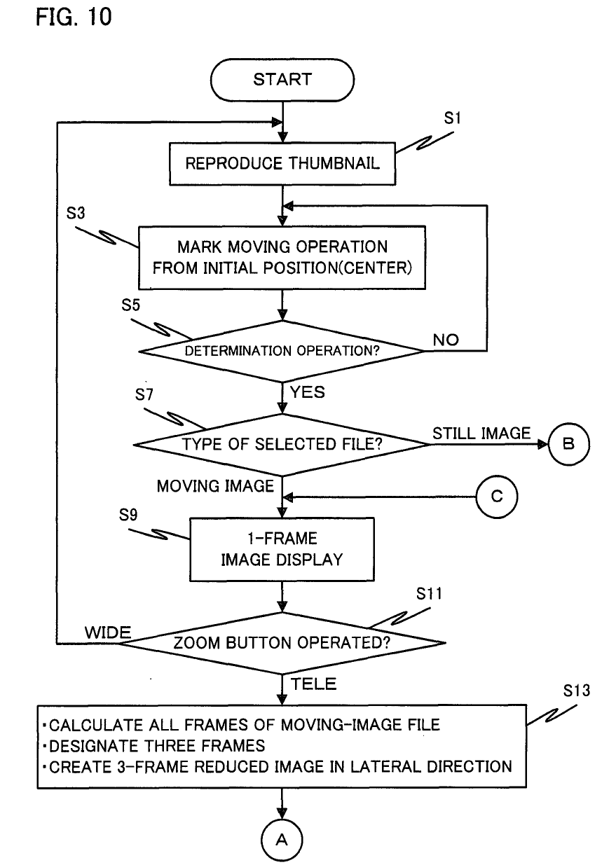

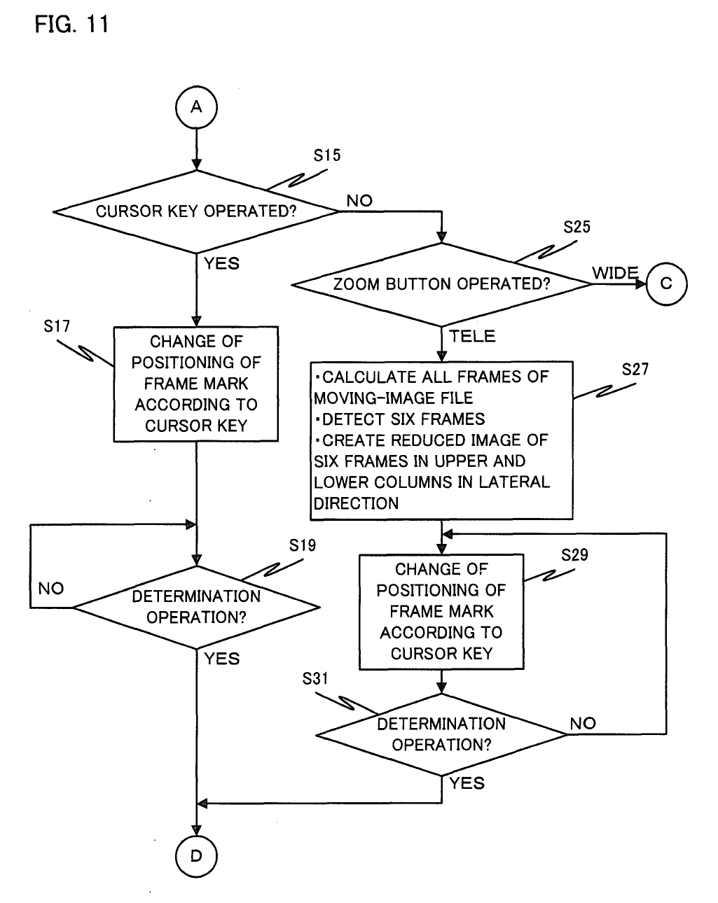

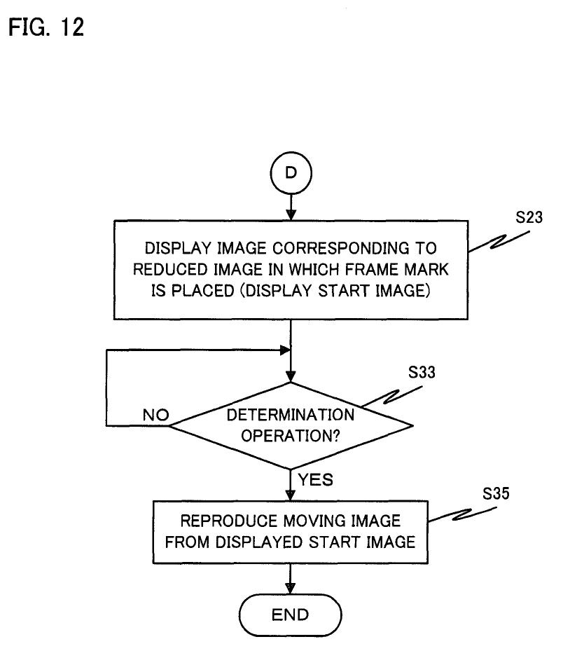

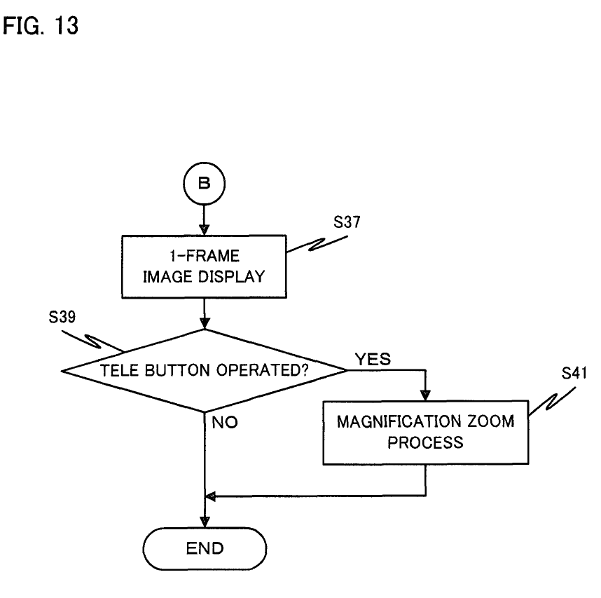

Next, the process performed by the CPU 26 in the reproduction mode described by using FIG. 3 to FIG. 8 is described by using flowcharts from FIG. 10 to FIG. 13.

When the reproduction button 2d is depressed, the CPU 26 proceeds to a step S1 to display the thumbnail display image shown in FIG. 3 on the display portion 4. Next, the process proceeds to a step S3 to move the frame mark 100 of a desired selected thumbnail from an initial position (center) based on an operation of the cursor key 2g. Then, the process proceeds to a step S5 to determine a determination operation, i.e., whether or not the center portion of the cursor key 2g is depressed. When NO is determined in the step S5, the process returns to the step S3. Alternatively, when YES is determined in the step S5, the process proceeds to a step S7 to determine a type of a file corresponding to the selected thumbnail.

When the CPU 26 determines in the step S7 that the file is the moving image file, the process proceeds to a step S9 to display on the display portion 4 the still image of a first one frame out of a plurality of frames forming the moving image file, as shown in FIG. 4. Then, the process proceeds to a step S11 to determine an operation of the zoom button 21, i.e., to determine which button, the TELE button 2b or the WIDE button 2c, is depressed in this step. When it is determined that the TELE button 2b is depressed, the process proceeds to a step S13, and when it is determined that the WIDE button 2c is depressed, the process returns to the step S1 to perform the thumbnail display reproduction again.

In the step S13, the CPU 26 designates three frames out of all the frames configuring the moving image file, creates first reduced images of the three frames, and displays the first reduced images of the three frames in a lateral direction as shown in FIG. 5. A designating method of the three frames is similar to that in which in the aforementioned display state shown in FIG. 4, when the TELE button 2b is depressed, the first reduced display image configured by the three first reduced images is displayed on the display portion 4, as shown in FIG. 5.

Then, the CPU 26 proceeds to a step S15 to determine whether or not the cursor key 2g is operated. When YES is determined in the step S15, the process proceeds to a step S17 to move the frame mark 100 according to an operation of the cursor key 2g, and then, the process proceeds to a step S19. In the step S19, a determination operation is determined, i.e., it is determined whether or not the center portion of the cursor key 2g is depressed. When NO is determined in this step, a determination is made again in the step S19. When YES is determined, the process proceeds to a step S23.

Alternatively, when NO is determined in the determination in the step S15, the CPU 26 proceeds to a step S25. In the step S25, an operation of the zoom button 21 is determined. In this case, it is determined which button, the TELE button 2b or the WIDE button 2c, is depressed. When it is determined that the WIDE button 2c is depressed, the process returns to the step S9, and when it is determined that the TELE button 2b is depressed, the process proceeds to a step S27.

The CPU 26 designates six frames out of all the frames configuring the moving image file in the step S27, creates second reduced images of the six frames, and displays the second reduced images of the six frames in the upper and lower columns in a lateral direction, as shown in FIG. 6. The designating method of the six frames is similar to that in which in the aforementioned display state shown in FIG. 5, when the TELE button 2b is depressed again, the second reduced display image configured by the six second reduced images is displayed on the display portion 4, as shown in FIG. 6.

Then, the process proceeds to a step S29, and the CPU 26 causes the frame mark to move according to an operation of the cursor key 2g, and then, the process proceeds to a step S31. In the step S31, it is determined whether or not the center portion of the cursor key 2g is depressed. When NO is determined in this step, the process returns to the step S29 again, and when YES is determined, the process proceeds to the step S23.

In the step S23, the CPU 26 displays the 1-frame digital image data of the first reduced image or the second reduced image in which the frame mark 100 is placed as shown in FIG. 8. Then, the process proceeds to a step S33 to determine a determination operation, i.e., whether or not the central portion of the cursor key 2g is depressed. The determination in the step S33 is repeated until YES is determined, and when YES is determined, the process proceeds to a step S35. In the step S35, the digital image data displayed in the step S23 is used as a head frame of the moving-image reproducing process, and in this state, the moving-image reproducing process is performed in a time sequence.

Alternatively, when the CPU 26 determines in the step S7 that the file is the still image file, the process proceeds to a step S37 to display on the display portion 4 the 1-frame still image corresponding to the thumbnail enclosed by the frame mark 100 in the step S2, as shown in FIG. 9(a). Next, the process proceeds to a step S39 to determine whether or not the TELE button 2b is operated. When YES is determined, the still image displayed in the step S37 is displayed to be magnified as shown in FIG. 9(b), and then, a series of processes are ended. Alternatively, when NO is determined in the step S39, the same is applied.

Thus, in the electronic camera 10 of this embodiment, the reduced images of a plurality of frames of image data, designated by a first interval from a series of a plurality of frames configuring a moving image file are collectively displayed, and thus, it is possible to display the content of the moving image file to the user in a more understandable manner.

Furthermore, in the electronic camera 10 of this embodiment, in the reproduction mode, when a predetermined operation is performed in the thumbnail display state, the first-reduced-image display state, or the second-reduced-image display state, the reduced images of the image data of a plurality of frames corresponding to each of the display states of the moving image file are collectively displayed. Thus, with a simple operation, it is possible to display to the user the content of the moving image file in a visually understandable manner.

Furthermore, in the aforementioned embodiment, when the TELE button 2b is depressed in the thumbnail display state, the first reduced display image is displayed, and when the TELE button 2b is depressed in the display state of the first reduced display image, the second reduced display image is displayed. However, when the TELE button 2b is depressed for two consecutive times in the thumbnail display state, the second reduced display image may be displayed without displaying the first reduced display image. In that case, a counter not shown is provided in the CPU 26 to count the number of times that the TELE button 2b is depressed in each of the display states, and a display is made corresponding to the number of times.

Additionally, in the above-described embodiment, the Motion JPEG file is used, as the moving image file, to describe the embodiment. However, the moving image file is not limited thereto, and an MPEG file, for example, may be applied. In this case, the thumbnail images for a moving image may be generated based on I pictures forming the moving image file. Furthermore, a plurality of first reduced images as shown in FIG. 5 may be generated based only on the I pictures. Alternatively, the first reduced images may be generated based on both the I pictures and P pictures, or based on each of the I pictures, the P pictures and B pictures. In this case, an arrangement of each of the frames is configured according to a time axis. The same applies to a plurality of second reduced images as shown in FIG. 6.

In addition, in the aforementioned embodiment, the process for generating the first reduced images from the moving image file is performed after the depression of the TELE button 2b is detected. However, upon recording, as the moving image file, in the external memory card 40, the first reduced images and the second reduced images may be generated and recorded in a manner to be associated with the moving-image data. Alternatively, after the moving-image data is recorded, the first reduced images and the second reduced images may be generated and recorded. Therefore, it is possible to shorten a time required for displaying on the display portion 4 the plurality of first reduced images and second reduced images as shown in FIG. 5 and FIG. 6.

Furthermore, the numbers of first reduced images and the second reduced images displayed in response to the depression of the TELE button 2b are not restricted to 3×N (N=the number of times of the depression of the TELE button 2b after a first one frame of the moving image file selected from the thumbnail display state is displayed: three and six in FIG. 5 and FIG. 6, respectively, in this embodiment) in the aforementioned embodiment, and may be M×N (M=integers of >2).

Furthermore, in the aforementioned embodiment, it is described that when the frames corresponding to the first reduced images are determined, the frame corresponding to the even point obtained by dividing the moving image file configured by 1800 frames by two is the 900th frame. However, the even point is not limited thereto, and a 901st frame may be the even point. Furthermore, when the frames corresponding to the second reduced images are determined, in a case that the even point obtained by diving all the frames by five is not evenly determined, the even point may not be even and be deviated by a few frames. Likewise, in the aforementioned embodiment, it is described that when the frames corresponding to the first reduced images are determined, a frame corresponding to the even point obtained by dividing the moving image file configured by 1800 frames by two is as the 900th frame, and in this state, the first one frame, the determined one frame, and the last one frame are designated. However, the present invention is not limited thereto, and frames of every L frames may be the first reduced images, for example. In this case, the frames corresponding to the first reduced images are a first one frame, an L-th frame, a 2L-th frame.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A moving-image reproducing apparatus for reproducing a moving image file formed of a plurality of frames, comprising:
a first displayer for displaying one frame of reference of the moving image file;
a second displayer for collectively displaying reduced images corresponding to image data of a first predetermined number of frames, out of the plurality of frames forming the moving image file, when a predetermined operation is performed in a display state by the first displayer; and
a third displayer for collectively displaying reduced images corresponding to image data of a second predetermined number of frames, the second predetermined number being larger than the first predetermined number, out of the plurality of frames forming the moving image file, when the predetermined operation is performed in a display state by the second displayer.

2. A moving-image reproducing apparatus according to claim 1, wherein each of frames corresponding to reduced images of the first predetermined number of frames is image data designated by a first interval from the moving image file.

3. A moving-image reproducing apparatus according to claim 1, wherein each of frames corresponding to reduced images of the second predetermined number of frames is image data designated by an interval shorter than the first interval from the moving image file.

4. A moving-image reproducing apparatus according to claim 1, further comprising:
in one of a display of reduced images of the first predetermined number of frames and a display of reduced images of the second predetermined number of frames,
a first selector for selectively selecting the reduced images;
a detector for detecting time positions in a moving image file of the image data corresponding to the reduced images selected by the first selector; and
a reproducer for reproducing the moving image file from the time positions.

5. A moving-image reproducing apparatus according to claim 1, further comprising:
a still-image reproducer for reproducing a still image file;
a magnifying-process acceptor for accepting a magnifying operation for applying a magnifying process in an electronic manner to a still image of the still image file reproduced in the still-image reproducer; and
a magnifying processor for executing the magnifying process according to the magnifying operation, wherein
the predetermined operation is the magnifying operation.

6. A moving-image reproducing apparatus for reproducing a moving image file formed of a plurality of frames, comprising:
a first displayer for displaying one frame of reference of the moving image file;
an operator for accepting an operation instruction for executing a predetermined operation;
a counter for counting the number of times of the operation instruction; and
a second displayer for changing reduced images of image data of a plurality of frames of the moving image file, according to output of the counter, so as to collectively display the changed reduced images.

7. A moving-image reproducing method for reproducing a moving image file formed of a plurality of frames, the moving-image reproducing method comprising:
a first step of displaying one frame of reference of the moving image file;
a second step of collectively displaying reduced images corresponding to image data of a first predetermined number of frames, out of the plurality of frames forming the moving image file, when a predetermined operation is performed in a display state by the first displayer; and
a third step of collectively displaying reduced images corresponding to image data of a second predetermined number of frames, the second predetermined number being larger than the first predetermined number, out of the plurality of frames forming the moving image file, when the predetermined operation is performed in a display state by the second displayer.
